(19) United States
(12) Patent Application Publication
(10) Pub. No.: US 2003/0044169 A1
(43) Pub. Date: Mar. 6, 2003

(54) Monitor image recorder

(75) Inventor: Toshihiro Shimizu, Sagamihara-shi (JP)

Correspondence Address: PEARNE & GORDON LLP, 526 SUPERIOR AVENUE EAST, SUITE 1200, CLEVELAND, OH, 44114-1484, US

(73) Assignee: Matsushita Electric Industrial Co., Ltd.

(21) Appl. No.: 10/230,506

(22) Filed: Aug. 29, 2002

(30) Foreign Application Priority Data
Aug. 31, 2001 (JP) P. 2001-264237

(51) Int. Cl. H04N 5/225; H04N 5/76

(52) U.S. Cl. 386/117; 348/207.99

(57) ABSTRACT

Picked up image information is recorded in a recorder 5 through an image switching unit, a record data encoding control unit, an encoder and a record data transfer control unit. A recording management information holding unit holds information for specifying monitor cameras to record picked up images, the recording density information and recording time information of the picked up images of the specified monitor cameras. A system control unit refers to event information inputted from an event detecting unit and the information of the recording management information holding unit to extract information for specifying images to be recorded in the recorder and the recording density information thereof and control a recording operation.

### BACKGROUND OF THE INVENTION

The present invention relates to a monitor image recorder for recording monitor images picked up by monitor cameras coordinated with events in association with the generation of the events such as alarms.

There has been well-known a monitor image recorder picks up images of an area to be monitored by a plurality of monitor cameras and records the picked up images. Such a monitor image recorder not only records the picked up images from the monitor cameras, but also detects the generation of events such as alarms by a moving object detecting sensor and an alarm switch. The monitor image recorder is operated in association with the generation of the events, so that it can perform a recording operation for a long time.

As a method for carrying out a recording operation in association with the generation of the event, a method has been known for shortening an interval for recording picked up images from a camera corresponding to the event.

However, the above-described method has a problem that the picked up images of a required camera cannot be recorded for necessary time, when the events are continuously generated.

### SUMMARY OF THE INVENTION

The present invention is proposed by taking the above-described circumstances into consideration, and it is an object to provide a monitor image recorder capable of efficiently recording picked up images from a camera coordinated with an event.

A monitor image recorder according to the present invention serves to record monitor images in association with the generation of events, and comprises an image switching unit which switches and outputs images picked up by a plurality of monitor cameras disposed at prescribed positions in an area to be monitored; an image recording unit which records the output images of the image switching unit; a record management information holding unit which holds information for specifying the monitor cameras to record the picked up images correspondingly to the respective events and the recording density information and recording time information of the picked up images of the specified cameras; and a control unit to which event information representing the generation of the event is inputted to refer to the inputted event information and the information of the record management information holding unit, extract information for specifying images to be recorded in the image recording unit and the recording density information thereof and control the recording operation of the image recording unit.

Further, the control unit in the monitor image recorder according to the present invention selects the images to be recorded and controls the recording density under the control of the image switching unit. Accordingly, a wasteful image processing is not necessary and a processing burden is reduced.

Further, when the total value of the extracted recording density information exceeds a limit value of the monitor image recorder, the control unit in the monitor image recorder according to the present invention controls the recording operation of the image recording unit by using the recording density obtained as a result of reducing the recording densities at the same rate until the total value reaches the limit value. Thus, the recording operation meeting the capacity of the device can be efficiently carried out.

The monitor cameras in the monitor image recorder according to the present invention are grouped and, when the total value of the extracted recording density information exceeds the limit value, the control unit reduces the recording densities at the same rate for each of the picked up images of the grouped monitor cameras. Thus, the images to be monitored can be thoroughly recorded.

Still further, in the monitor image recorder according to the present invention, the monitor cameras are grouped depending on the area where the monitor cameras are disposed.

### BRIEF DESCRIPTION OF THE DRAWINGS

FIG. 1 shows a schematic structure of a monitor image recorder according to the present invention;

FIG. 2 shows one example of information held in a recording management information holding unit of the monitor image recorder of the present invention;

FIG. 3 shows one example of information held in a group management information holding unit of the monitor image recorder of the present invention;

FIG. 4 shows one example of a time chart showing the operation of the monitor image recorder of the present invention;

FIG. 5 shows the recording densities of images from respective cameras in the respective sections of FIG. 4;

FIG. 6 shows another example of a time chart showing the operation of the monitor image recorder according to the present invention;

FIG. 7 shows another example of information held in the recording management information holding unit of the monitor image recorder of the present invention; and

FIG. 8 shows recording densities of images from the respective cameras in the respective sections shown in FIG. 6.

### DETAILED DESCRIPTION OF THE PREFERRED EMBODIMENT

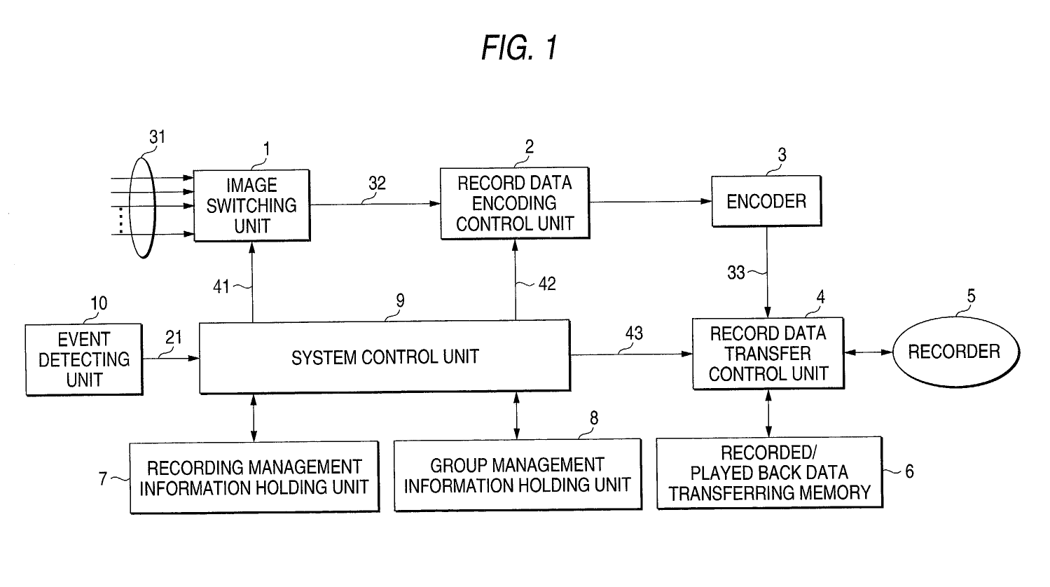

Now, an embodiment of the present invention will be described below by using drawings. FIG. 1 shows a schematic structure of an embodiment of a monitor image recorder according to the present invention. The monitor image recorder shown in FIG. 1 includes an image switching unit 1, a record data encoding control unit 2, an encoder 3, a record data transfer control unit 4, a recorder 5, a recorded/played back data transferring memory 6, a recording management information holding unit 7, a group management information holding unit 8 and a system control unit 9. Event information 21 is inputted from an event detecting unit 10 and picked up image signals 31 are inputted from a plurality of monitor cameras which are not shown.

The image switching unit 1 selects and outputs the picked up image signals 31 in accordance with a control signal 41 from the system control unit 9. A selected picked up image signal 32 is digitized by an A/D converter which is not shown and the digitized signal is sent to the record data encoding control unit 2. The record data encoding control unit 2 fetches the digitized picked up image signal 32 to a frame memory (not shown) in accordance with a control signal 42 of the system control unit 9 to control the encoding process of an image. The encoder 3 encodes image data under the control of the record data encoding control unit 2 to send encoded data 33 to the record data transfer control unit 4.

The record data transfer control unit 4 temporarily stores encoded data 44 in the recorded/played back data transferring memory 6 and records it in the recorder 5 such as a hard disk under prescribed conditions and timing. The operation of the record data transfer control unit 4 is controlled on the basis of a control signal 43 from system control unit 9.

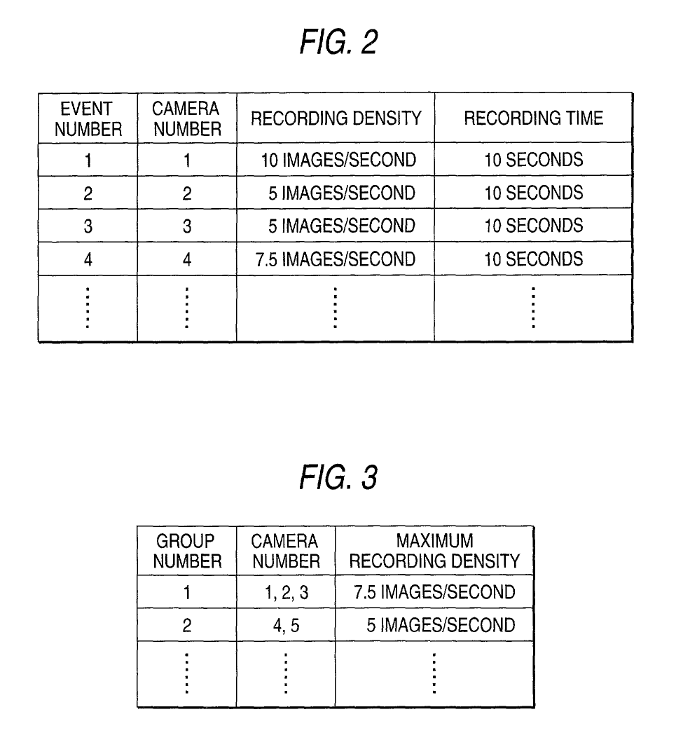

The recording management information holding unit 7 serves to hold information for specifying monitor cameras to record the picked up images correspondingly to an event such as an alarm and recording density information and recording time information when the picked up images of the specified monitor cameras are recorded. FIG. 2 shows one example of information held in the recording management information holding unit 7. For instance, when an event 1 is generated, an image picked up by the monitor camera of a camera number 1 is recorded with the recording density of 10 images per second for 10 seconds. In the example shown in FIG. 2, although one monitor camera is made to correspond to one event, a plurality of cameras may be made to correspond to one event.

The group management information holding unit 8 is provided when the monitor cameras are grouped and the recording density of images from the monitor cameras belonging to the same group is limited to a specific value. FIG. 3 shows one example of information held in the group management information holding unit 8. As shown in FIG. 3, the monitor cameras 1, 2 and 3 are included in the group 1 and the total value of the recording density of the picked up images from the monitor cameras 1, 2 and 3 is limited to 7.5 images/second. There will be described below as to which case the maximum recording density information is employed.

In order to uniformly record monitor images to be monitored, the monitor cameras are grouped. For instance, the group is set to each area where the respective cameras are disposed. Accordingly, even when a plurality of events in which the images of the monitor cameras belonging to the same area are recorded are inputted, it is prevented that a proper record cannot be performed caused by reducing the recording density of the images of the monitor cameras belonging to another area. In this case, the monitor cameras may be grouped not only depending on areas where the cameras are disposed, but also depending on, for instance, kinds of events.

The system control unit 9 uses the information held by the recording management information holding unit 7 and the group management information holding unit 8 and the event information 21 from the event detecting unit 10 and controls to select the monitor images to be recorded and the recording density as well as controls entirely the monitor image recorder. As described below, the monitor images to be recorded and the recording density are preferably selected under the control of the image switching unit 1. However, the present invention is not limited thereto and, for instance, the selection of the monitor images and the recording density may be carried out under the control of the record data transfer control unit 4.

The event detecting unit 10 serves to detect the generation of an event such as an alarm and output different event information 21 depending on the kinds of events and the places of generation thereof. As a specific detecting unit, various kinds of sensors such as moving object detecting sensors of monitor areas and alarm switches or the like can be utilized.

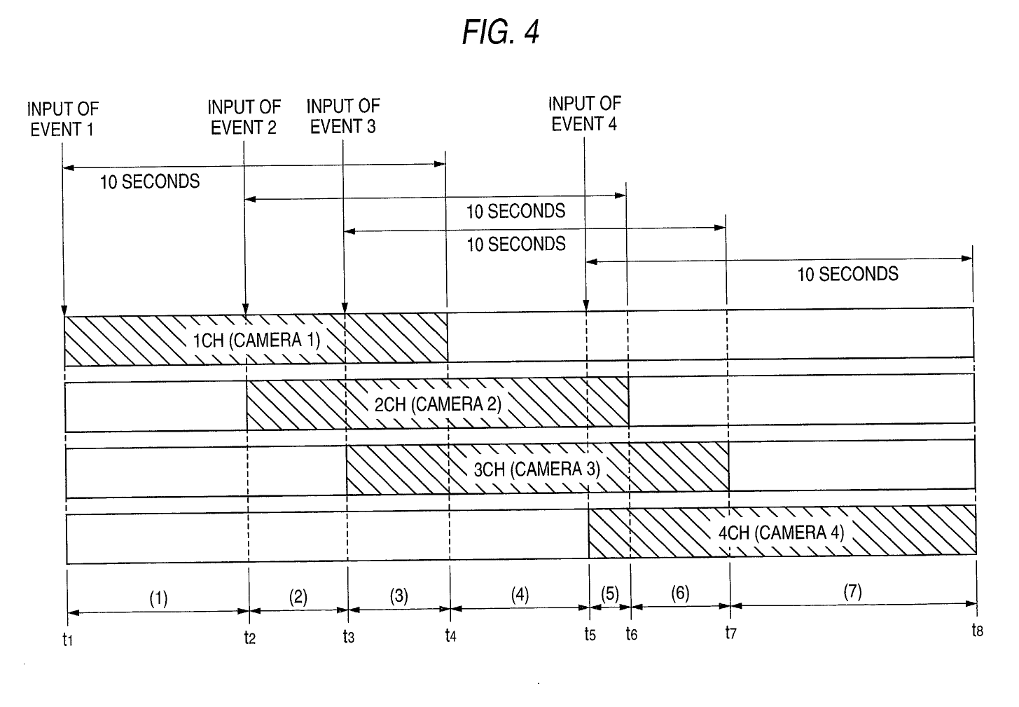

Now, the operation of the monitor image recorder shown in FIG. 1 is explained by referring to a time chart in FIG. 4. An example of FIG. 4 shows a time chart when the monitor cameras are not grouped. It is assumed that the information as shown in FIG. 2 is set to the recording management information holding unit 7, the picked up images of cameras 1 to 4 are inputted to 1 to 4 channels, and the limit value of the recording density of the monitor image recorder is 15 images/second.

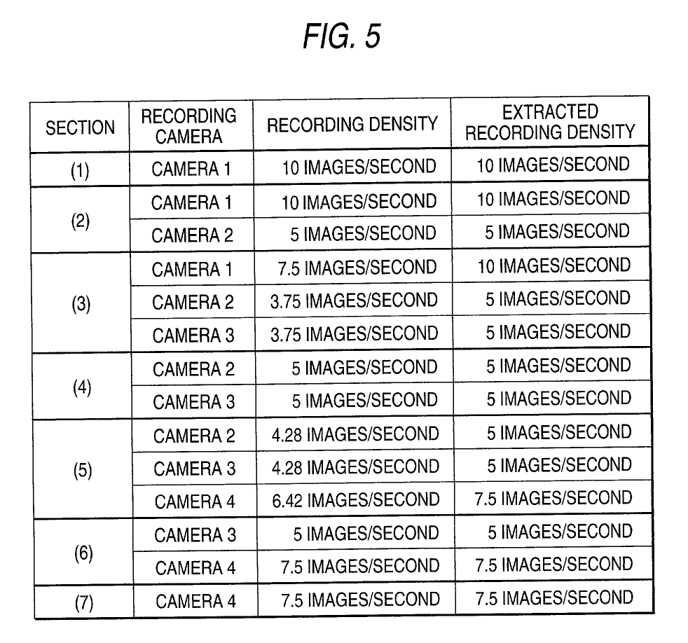

Now, it is assumed that an event 1 is generated at time t₁, an event 2 is generated at time t₂, an event 3 is generated at time t₃ and an event 4 is generated at time t₅, respectively. The time t₄ represents a point after 10 seconds from the time t₁, the time t₆ represents a point after 10 seconds from the time t₂, time t₇ represents a point after 10 seconds from the time t₃, and time t₈ represents a point after ten seconds from the time t₅. As shown in FIG. 2, when the events 1 to 4 are generated, the images picked up by the cameras 1 to 4 are preset to be recorded for 10 seconds, so that the image of the channel 1 is recorded from the time t₁ to the time t₄, the image of the channel 2 is recorded from the time t₂ to the time t₆, the image of the channel 3 is recorded from the time t₃ to the time t₇, and the image of the channel 4 is recorded from the time t₅ to the time t₈ with the prescribed recording densities, respectively. FIG. 5 shows the recording densities of the images from respective cameras in each section. An extracted recording density shown in FIG. 5 indicates the recording density of an image corresponding to each camera which is extracted from the recording management information holding unit 7 on the basis of the event information.

In a section (1) (from the time t₁ to the time t₂), only images are selected from the camera 1. The total value of the recording density extracted from the recording management information holding unit 7 is 10 images/second, which is not higher than a limit value, so that the images are recorded with the extracted recording density. Likewise, since, in a section (2) (from the time t₂ to the time t₃), a section (4) (from the time t₄ to the time t₅), a section (6) (from the time t₆ to the time t₇) and a section (7) (from the time t₇ to the time t₈), the total value of the recording densities extracted from the recording management information holding unit 7 is not higher than the limit value, the images are recorded with the extracted recording density.

However, the total values of the recording densities extracted in a section (3) (from the time t₃ to the time t₄) and a section (5) (from the time t₅ to the time t₆) respectively exceed 20 images/second and 17.5 images/second, which exceed a limit value of 15 images/second. Therefore, the images cannot be recorded directly with the above-described recording densities. In this case, the system control unit 9 reduces the recording densities of the respective images at the same rate to change the total value to a value as the limit value of 15 images/second. That is, in the section (3), the respective extracted densities are multiplied by 15/20 to record the image of the camera 1 with the recording density of 7.5 images/second, the image of the camera 2 with the recording density of 3.75 images/second and the image of the camera 3 with the recording density of 3.75 images/second. Further, in the section (5), the respective recording densities are multiplied by 15/17.5 to record the image of the camera 2 with the recording density of 4.28 images/second, the image of the camera 3 with the recording density of 4.28 images/second and the image of the camera 4 with the recording density of 6.42 images/second.

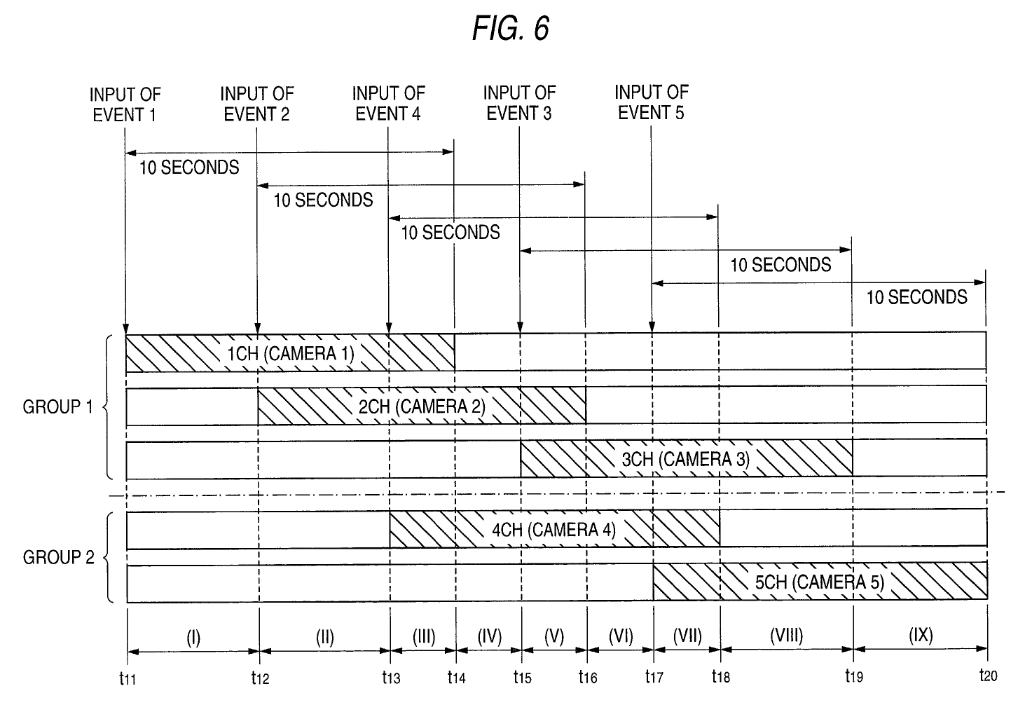

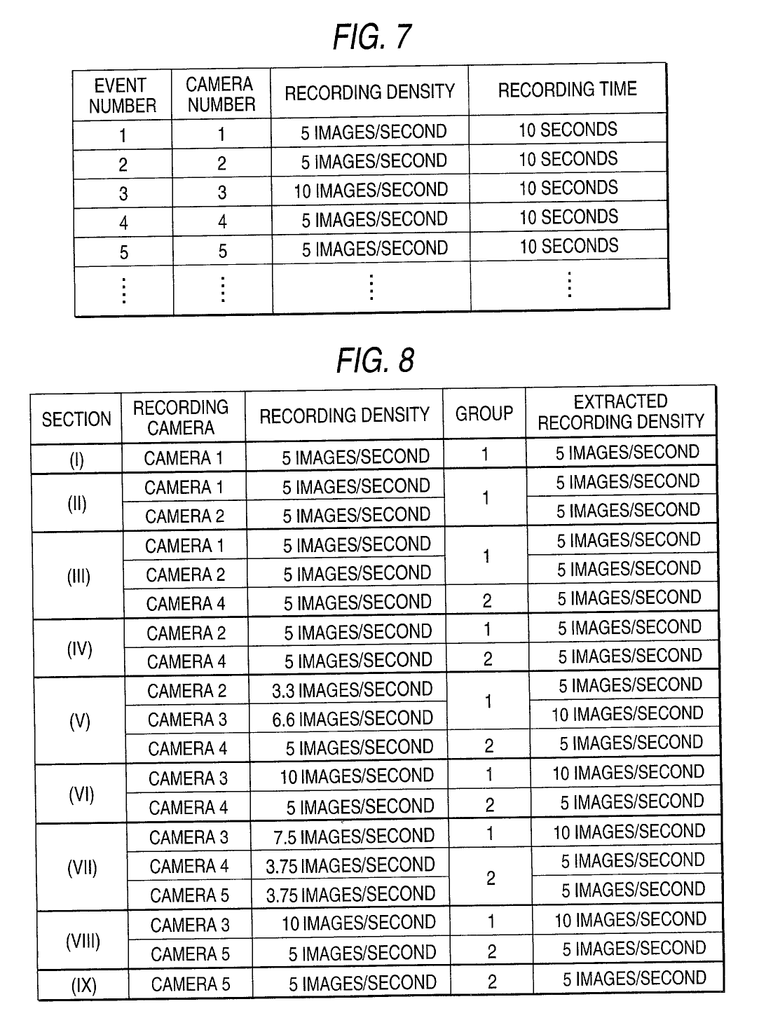

Now, the operation of the monitor image recorder when the monitor cameras are grouped will be explained by using a time chart shown in FIG. 6. It is assumed that information as shown in FIG. 7 is preset to the recording management information holding unit 7, the picked up images of cameras 1 to 5 are inputted to 1 to 5 channels of the image switching unit and the limit value of the recording density of the monitor image recorder is 15 images/second. Further, it is assumed that information as shown in FIG. 3 is preset to the group management information holding unit 8.

Now, it is assumed that an event 1 is generated at time t₁₁, an event 2 is generated at time t₁₂, an event 4 is generated at time t₁₃, an event 3 is generated at time t₁₅ and an event 5 is generated at time t₁₇, respectively. The time t₁₄ represents a point after 10 seconds from the time t₁₁, the time t₁₆ represents a point after 10 seconds from the time t₁₂, the time t₁₈ represents a point after 10 seconds from the time t₁₃, the time t₁₉ represents a point after 10 seconds from the time t₁₅, and the time t₂₀ represents a point after 10 seconds from the time t₁₇. As shown in FIG. 7, when the events 1 to 5 are generated, the images picked up by the cameras 1 to 5 are preset to be recorded for 10 seconds, so that the image of the channel 1 is recorded from the time t₁₁ to the time t₁₄, the image of the channel 2 is recorded from the time t₁₂ to the time t₁₆, the image of the channel 3 is recorded from the time t₁₅ to the time t₁₉, the image of the channel 4 is recorded from the time t₁₃ to the time t₁₈ and the image of the channel 5 is recorded from the time t₁₇ to the time t₂₀ with the prescribed recording densities, respectively. FIG. 8 shows the recording densities of the images from respective cameras in each section. An extracted recording density shown in FIG. 8 indicates the recording density of an image corresponding to each camera which is extracted from the recording management information holding unit 7 on the basis of the event information.

In a section (I) (from the time t₁₁ to the time t₁₂), only images are selected from the camera 1. The total value of the recording density extracted from the recording management information holding unit 7 is 5 images/second, which is not higher than a limit value, so that the images are recorded with the extracted recording density. Likewise, since, in a section (II) (from the time t₁₂ to the 0time t₁₃), a section (III) (from the time t₁₃ to the time t₁₄), a section (IV) (from the time t₁₄ to the time t₁₅), a section (VI) (from the time t₁₆ to the time t₁₇), a section (VIII) (from the time t₁₈ to the time t₁₉), and a section (IX) (from the time t₁₉ to the time t₂₀), the total value of the recording densities is not higher than the limit value, the images are recorded with the extracted recording density.

However, both the total values of the recording densities extracted in a section (V) (from the time t₁₅ to the time t₁₆) and a section (VII) (from the time t₁₇ to the time t₁₈) are 20 images/second, which exceed a limit value of 15 images/second. Therefore, the images cannot be recorded directly with the above-described recording densities. In this case, the system control unit 9 extracts the maximum recording densities for each camera number included in the group and for each group from the group management information holding unit 8 and reduces the recording density for each group so that the total value of the recording densities for each group becomes the preset maximum recording density.

In the section (V), since the total value of the extracted recording densities of a group 1 is 15 images/second and the total value of the extracted recording density of a group 2 is 5 images/second. Since the group 2 does not exceed the maximum recording density, the image of the camera 4 belonging to the group 2 is directly recorded with the extracted recording density of 5 images/second. Then, the extracted recording densities of the cameras belonging to the group 1 are multiplied by 10/15 so that the total value of the recording densities of the group 1 becomes 10 images/second obtained by subtracting 5 images/second assigned to the group 2 from the limit value of 15 images/second to record the image of the camera 2 with the recording density of 3.3 images/second and the image of the camera 3 with the recording density of 6.6 images/second.

In the section (VII), since the total value of the extracted recording density of a group 1 is 10 images/second and the total value of the extracted recording densities of a group 2 is 10 images/second and the total values of both the groups exceed the maximum recording density, the recording density is reduced for each group. That is, the image of the camera 3 belonging to the group 1 is recorded with the recording density of 7.5 images/second. The images of the cameras 4 and 5 belonging to the group 2 are both recorded with the recording density of 3.75 images/second obtained after such a process that the respective extracted recording densities are multiplied by 7.5/10 so that the total value of the recording densities becomes 7.5 images/second got by subtracting 7.5 images/second assigned to the group 1 from the limit value of 15 images/second.

As apparent from the above description, according to the present invention, the monitor image recorder can be provided in which picked up images from the cameras coordinated with events can be efficiently recorded.

What is claimed is:

1. A monitor image recorder for recording monitor images in association with the generation of events, comprising:
an image switching unit which switches and outputs images picked up by a plurality of monitor cameras disposed at prescribed positions in an area to be monitored;
an image recording unit which records the output images of the image switching unit;
a recording management information holding unit which holds information for specifying the monitor cameras to record the picked up images correspondingly to the respective events and the recording density information and recording time information of the picked up images of the specified cameras; and
a control unit to which event information representing the generation of the event is inputted to refer to the inputted event information and the information of the recording management information holding unit, extract information for specifying images to be recorded in the image recording unit and the recording density information thereof and control the recording operation of the image recording unit.

2. The monitor image recorder as claimed in claim 1, wherein the control unit selects the images to be recorded and controls the recording density under the control of the image switching unit.

3. The monitor image recorder as claimed in claim 1, wherein, when the total value of the extracted recording density information exceeds a limit value of the monitor image recorder, the control unit controls the recording operation of the image recording unit by using the recording density obtained as a result of reducing the recording densities at the same rate until the total value reaches the limit value.

4. The monitor image recorder as claimed in claim 3,
wherein the monitor cameras are grouped
wherein, when the total value of the extracted recording density information exceeds the limit value, the control unit reduces the recording densities at the same rate for each of the picked up images of the grouped monitor cameras.

5. The monitor image recorder as claimed in claim 4, wherein the monitor cameras are grouped depending on the area where the monitor cameras are disposed.
